(19) United States
(12) Patent Application Publication
(10) Pub. No.: US 2020/0020957 A1
(43) Pub. Date: Jan. 16, 2020

(54) FUNCTIONALIZED, POROUS GAS CONDUCTION PART FOR ELECTROCHEMICAL MODULE

(71) Applicant: PLANSEE SE, REUTTE (AT)

(72) Inventors: CHRISTIAN BIENERT, REUTTE (AT); WOLFGANG SCHAFBAUER, REUTTE (AT); MATTHIAS RUETTINGER, REUTTE (AT)

(21) Appl. No.: 16/494,483

(22) PCT Filed: Feb. 22, 2018
(86) PCT No.: PCT/AT2018/000008

§ 371 Date: Sep. 16, 2019

(30) Foreign Application Priority Data
Mar. 16, 2017 (AT) GM 55/2017

(51) Int. Cl. H01M 8/0232; H01M 8/0273; H01M 8/026; H01M 8/2432; H01M 8/2483; H01M 8/0612; H01M 8/0662

(52) U.S. Cl. CPC H01M 8/0232; H01M 8/0273; H01M 8/026; H01M 2008/1293; H01M 8/2483; H01M 8/0618; H01M 8/0681; H01M 8/2432

(57) ABSTRACT

A porous or at least sectionally porous gas conduction part is provided for an electrochemical module. The electrochemical module has at least one electrochemical cell unit having a layer construction with at least one electrochemically active layer, and a metallic, gastight housing which forms a gastight process gas space with the electrochemical cell unit. The housing extends on at least one side beyond the region of the electrochemical cell unit, and forms a process gas conduction space open to the electrochemical cell unit, and in the region of the process gas conduction space has at least one gas passage opening for the supply and/or removal of the process gases. The gas conduction part here is adapted for arrangement within the process gas conduction space and its surface is functionalized for interaction with the process gas.

The present invention relates to a functionalized, porous gas conduction part for arrangement in an electrochemical module according to claim 1 and claim 4 and to an electrochemical module according to claim 18.

The porous gas conduction part of the invention is used in an electrochemical module which can be employed as, among other things, a high-temperature fuel cell or solid oxide fuel cell (SOFC), as a solid oxide electrolysis cell (SOEC; solid oxide electrolyser cell) and also as a reversible solid oxide fuel cell (R-SOFC). In the basic configuration, an electrochemically active cell of the electrochemical module comprises a gastight solid-state electrolyte which is arranged between a gas-permeable anode and a gas-permeable cathode. The electrochemically active components here, such as anode, electrolyte and cathode, are frequently designed as comparatively thin layers. A mechanical support function needed as a result may be provided by one of the electrochemically active layers, such as by the electrolyte, the anode or the cathode, for example, which in that case are each designed with corresponding thickness (in these cases, the system is referred to as an electrolyte-, anode- or cathode-supported cell, respectively), or by a component designed separately from these functional layers, such as a ceramic or metallic support substrate, for example. In the case of the latter approach, with a metallic support substrate designed separately, the system is referred to as a metal substrate-supported cell (MSC; metal-supported cell). Given the fact that in the case of an MSC, the electrolyte, whose electrical resistance falls as the thickness decreases and the temperature increases, can be given a comparatively thin design (e.g. with a thickness in the range from 2 to 10 μm), MSCs can be operated at a comparatively low operating temperature of around 600° C. to 800° C. (whereas, for example, electrolyte-supported cells are operated in some cases at operating temperatures of up to 1000° C.). On account of their specific advantages, MSCs are suitable in particular for mobile applications, such as, for example, for the electrical supply of passenger cars or commercial vehicles (APU—auxiliary power unit).

The electrochemically active cells are customarily designed as planar individual elements, which are arranged one above another in connection with corresponding (metallic) housing parts (e.g. interconnector, frame panel, gas lines, etc.) to form a stack, and are electrically contacted in series. Corresponding housing parts, in the individual cells of the stack, bring about the supply of the process gases separately from one another in each case—in the case of a fuel cell, the supply of the fuel (for example, hydrogen or hydrocarbon-containing fuels such as natural gas or biogas) to the anode and of the oxidant (oxygen, air) to the cathode—and also the removal, on the anode side and cathode side, of the gases formed in the electrochemical reaction. Based on an individual electrochemical cell, a process gas space is formed on either side of the electrolyte within a stack, and for the functioning of the stack it is essentially important that these spaces have reliable gastight separation from one another. The stack may be implemented in a closed construction or, as described by way of example in EP 1 278 259 B1, in an open construction, in which case only one process gas space is sealed off in a gastight manner, the anode-side process gas space, for example, in the case of a fuel cell, in which the fuel is supplied and/or the reaction product is taken off, while the oxidant, for example, flows freely through the stack.

Particularly in the operation of the electrochemical module as a fuel cell with hydrocarbon-containing fuels such as natural gas, a variety of challenges occur in use: The fuel cell is very sensitive towards impurities in the fuel of sulfur or chlorine, for example, which are significantly detrimental to the efficiency and lifetime and for which corresponding precautions must be taken. Furthermore, hydrogen gas must be generated for the electrochemical reaction from the hydrocarbon-containing fuel. One method industrially established for this is that of steam reforming, where hydrogen is released in an endothermic reaction, usually in an apparatus which is upstream of and spatially separate from the stack. In addition to this external reforming, there is what is called internal reforming known, where the hydrogen generation and the electrochemical reaction proceed together at the anode and for that purpose the reforming catalyst is disposed directly at the anode or, in the case of an MSC, directly on the electrochemically active metallic support substrate, where the electrochemical reaction of the fuel cells takes place. One example of this is specified in US 2012/0121999 A1, wherein the electrochemically active region of the support substrate is functionalized with a reforming catalyst. An advantage of linking these two reactions lies in the direct heat transfer, since the electrochemical reaction is an exothermic reaction, while the reforming is endothermic. Disadvantageous, however, are possible instances of carbon deposition or coking in the active region of the cell, particularly at the anode, which may adversely affect the electrochemical functioning of the cell.

Important for high efficiency of the electrochemical module is a uniform supply of the process gases to the electrochemically active layers, i.e., on the one hand, a uniform supply of the reactant gases and, respectively, a uniform removal of the reaction gases formed. The pressure drop is to be as small as possible. Within an electrochemical module, supply is performed in a horizontal direction by means of distributing structures which in general are integrated into the interconnector. Interconnectors, which also have the function of electrically contacting adjacent electrochemical cells, have gas conduction structures for this purpose on both sides, and these structures may have, for example, a knob-shaped, rib-shaped or wave-shaped design. For many applications, the interconnector is formed by an appropriately shaped metallic sheet part, which, in analogy to other components in the stack, is where possible extremely thin for the purpose of weight optimization. In the case of mechanical stresses of the kind occurring during manufacture or in the operation of the stack, particularly at the edge region, this thin configuration may easily lead to instances of deformation and/or cracking in the case of weld seams, thereby jeopardising the requisite gastight status.

A uniform supply with hydrogen is a challenge especially in the case of internal reforming, as in US 02012/0121999 A1, for example, since the formation of hydrogen is dependent on the incoming flow of fuel gas and, moreover, is closely coupled to the temperature distribution of the fuel cell.

The object of the present invention is to further develop an electrochemical module and to provide a gas conduction part with which the performance of the electrochemical module and/or its lifetime are/is positively influenced.

This object is achieved by the gas conduction part according to claim 1 and claim 4 and by an electrochemical module according to claim 18. Advantageous refinements are set forth in the dependent claims.

The gas conduction part of the invention is used for an electrochemical module which can be employed as a high-temperature fuel cell or solid oxide fuel cell (SOFC), as a solid oxide electrolysis cell (SOEC; solid oxide electrolyzer cell) and also as a reversible solid oxide fuel cell (R-SOFC). The basic construction of an electrochemical module of this kind features an electrochemical cell unit which has a layer construction with at least one electrochemically active layer and may also include a support substrate. Electrochemically active layers are understood here to refer, among others, to an anode, electrolyte or cathode layer, and the layer construction may optionally have further layers as well (made, for example, of cerium gadolinium oxide between electrolyte and cathode). Not all the electrochemically active layers must be present here; instead, the layer construction may also have only one electrochemically active layer (e.g. the anode), preferably two electrochemically active layers (e.g. anode and electrolyte), and the further layers, particularly those for completing an electrochemical cell unit, may not be applied until subsequently. The electrochemical cell unit may be designed as an electrolyte-supported cell, an anode-supported cell or as a cathode-supported cell (the layer giving the cell its name has a thicker configuration and takes on a mechanically load-bearing function). In the case of a metal substrate-supported cell (MSC), a preferred embodiment of the invention, the layer stack is arranged on a porous, plate-shaped, metallic support substrate having a preferred thickness typically in the range from 170 μm to 1.5 mm, more particularly in the range from 250 μm to 800 pm, in a gas-permeable, central region. The support substrate in this case forms part of the electrochemical cell unit. The layers of the layer stack are applied in a known way preferably by PVD (PVD: physical vapour deposition), such as, for example, by sputtering, and/or by thermal coating methods such as, for example, flame spraying or plasma spraying, and/or by wet-chemical methods such as, for example, screen printing, wet powder coating, etc.; for the realization of the overall layer construction of an electrochemical cell unit, it is also possible for two or more of these methods to be combined. Customarily, the anode is the electrochemically active layer immediately following the support substrate, while the cathode is formed on the side of the electrolyte remote from the support substrate. Alternatively, however, an inverted arrangement of the two electrodes is also possible.

Not only the anode (formed in the case of an MSC, for example, from a composite consisting of nickel and of zirconium dioxide fully stabilized with yttrium oxide) but also the cathode (formed in the case of an MSC, for example, from perovskites with mixed conductivity such as (La,Sr)(Co,Fe)O₃) have a gas-permeable design. Formed between anode and cathode is a gastight solid electrolyte comprising a solid, ceramic material made of metal oxide (e.g. of zirconium dioxide fully stabilized with yttrium oxide), which is conductive for oxygen ions, but not for electrons. Alternatively, the solid electrolyte may also be conductive for protons, with this relating to a more recent generation of SOFCs (e.g. solid electrolyte of metal oxide, more particularly of barium zirconium oxide, barium cerium oxide, lanthanum tungsten oxide or lanthanum niobium oxide).

The electrochemical module additionally has at least one metallic, gastight housing, which forms a gastight process gas space with the electrochemical cell unit. In the region of the electrochemical cell unit, the process gas space is bounded by the gastight electrolyte. On the opposite side, the process gas space is customarily bounded by the interconnector, which for the purposes of the present invention is also considered to be part of the housing. The interconnector is connected in gastight manner to the gastight element of the electrochemical cell unit, optionally in combination with additional housing parts, more particularly circumscribing frame panels or the like, which form the rest of the delimitation of the process gas space. In the case of MSCs, the gastight attachment of the interconnector is accomplished preferably by means of soldered connections and/or welded connections via additional housing parts, examples being circumscribing frame panels, which in turn are connected in a gastight manner to the support substrate and accordingly, together with the gastight electrolyte, form a gastight process gas space. In the case of electrolyte-supported cells, the attachment may take place by means of sintered connections or by application of sealant (e.g. glass solder).

“Gastight” in connection with the present invention means in particular that the leakage rate for sufficient gastight status amounts on a standard basis to <10⁻³ hPa*dm³/cm² s (hPa: hectopascal, dm³: cubic decimetre, cm²: square centimetre, s: second) (measured under air by pressure increase method using the Integra DDV instrument from Dr. Wiesner, Remscheid, at a pressure difference dp=100 hPa).

The housing extends on at least one side of the electrochemical cell unit beyond the region of the electrochemical cell unit and forms, as a sub-space of the process gas space, a process gas conduction space which is open to the electrochemical cell unit. The process gas space is therefore subdivided (theoretically) into two sub-regions, into an inner region directly below the layer construction of the electrochemical cell unit, and into a process gas conduction space surrounding the inner region.

In the region of the process gas conduction space there are gas passage openings made in the housing that serve for the supply and/or removal of the process gases. The gas passage openings may be integrated, for example, into the edge region of the interconnector and in housing parts such as circumscribing frame panels.

The supply of the electrochemical cell unit in the inner region of the process gas space takes place by means of distribution structures which are preferably integrated into the interconnector. The interconnector is preferably configured by an appropriately shaped, metallic sheet part, which for example has a knob-shaped, rib-shaped or wave-shaped design.

In the operation of the electrochemical module as an SOFC, the anode is supplied with fuel (for example hydrogen or conventional hydrocarbons, such as methane, natural gas, biogas, etc., optionally having been fully or partly reformed beforehand) via the gas passage opening and distribution structures of the interconnector, and this fuel is oxidized catalytically there, giving off electrons. The electrons are guided out of the fuel cell and flow via an electrical consumer to the cathode. At the cathode, an oxidant (oxygen or air, for example) is reduced through acceptance of the electrons. The electrical circuit is closed by the flow of the oxygen ions formed at the cathode via the electrolyte—in the case of an electrolyte conductive for oxygen ions—to the anode, and reaction with the fuel at the corresponding interfaces.

In the operation of the electrochemical module as a solid oxide electrolysis cell (SOEC), a redox reaction is forced using electrical current—for example, a conversion of water into hydrogen and oxygen. The construction of the SOEC corresponds essentially to the construction of an SOFC as outlined above, with the roles of cathode and anode being switched. A reversible solid oxide fuel cell (R-SOFC) can be operated either as an SOEC or as an SOFC.

According to the present invention, a gas conduction part is provided which is produced preferably by powder metallurgy and is therefore porous or at least sectionally porous, if aftertreated by pressing or local melting, for example, at the edge and/or on the surface. This gas conduction part is arranged in the region of the process gas conduction space. The porous structure of the gas conduction part serves to increase the surface area which is able to interact with the process gas in the region of the process gas conduction space. The surface of the gas conduction part is at least sectionally functionalized, thereby providing a reactive or catalytically active surface for manipulation of the process gases. By means of the functionalized surface, gases can be treated on the reactant side, and in particular can be purified and/or reformed, and gases on the product side can be after-treated, more particularly purified. Functionalization of the gas conduction part is accomplished by introducing into the material of the gas conduction part, and/or applying as a superficial coating, a material which acts catalytically and/or reactively with the process gas. The catalytic and/or reactive material may therefore be admixed to the actual starting powder for the production of the sintered gas conduction part (“alloyed in”) and/or may be applied to the surface of the gas conduction part which comes into contact with the process gas, by a coating procedure after the sintering operation. This coating procedure may take place by customary methods known to the skilled person, as for example by means of various deposition methods from the gas phase (physical vapour deposition, chemical vapour deposition), by dip coating (where the component is impregnated or infiltrated with a melt or solution comprising the corresponding functional material), or by means of methods for application of suspensions or pastes (especially for functionalization with ceramic materials). For the purpose of surface enlargement it is advantageous if the porous surface structure is retained during the coating procedure—that is, the porous surface is not to be overlayered with a top layer, but primarily only the (internal) surface of the porous structure is to be coated. Functionalization by a superficial coating is particularly advantageous overall since it necessitates comparatively less catalytic and/or reactive material than if the catalytic and/or reactive material is admixed to the material for the gas conduction part.

Through the arrangement of the functionalized gas conduction part in the region of the process gas conduction space, the chemical reactions for the manipulation of the process gases take place separately from the electrochemical reactions, which take place directly on the electrochemical cell unit. This separation has significant advantages: Any deposits or degradation on the gas conduction part do not have any direct adverse effect on the reactions in the electrochemical cell unit. Furthermore, different functionalizations are possible for the gas supply region and the gas removal region, and can be optimized independently for the particular requirement.

In one preferred variant implementation, the gas conduction part is configured as a separate component from the electrochemical cell unit and from the housing. The gas conduction part in this case is adapted for arrangement within the process gas conduction space; in other words, its shape is adapted to the interior of the process gas conduction space. This gas conduction part is preferably flat and possesses a flat body having one plane of principal extent. In one advantageous variant, the gas conduction part is configured as a support element in vertical direction (in the stack direction of the electrochemical modules). In this case its thickness is selected in accordance with the space internal height of the process gas conduction space, so that it bears by its top side against an upper housing part of the process gas conduction space and by its lower side on a lower housing part of the process gas conduction space, meaning that compression of the housing edge region when an applied pressure is applied is prevented. In the case of a flat design of the gas conduction part, moreover, the flexural and torsional stiffness of the housing edge region is increased and so the housing edge region is protected from instances of deflection or other deformations. In the edge region of the module it is possible, as a result, to avoid additional stresses on the weld seams or on other connecting points—for example, soldered or sintered connecting points—between the individual housing parts and/or the electrochemical cell unit, which in practice frequently represent weak points in terms of the gastight status.

In the operation of the electrochemical module, the separately implemented gas conduction part is arranged within the process gas conduction space, advantageously completely in the process gas conduction space, i.e.in the process gas space completely outside the region directly below the layer construction of the electrochemical cell unit.

Instead of a separate component arranged in the interior of the process gas conduction space, the functionalized gas conduction part, in a further embodiment, may be implemented as a delimitation of the process gas conduction space and/or of a section thereof (in other words as part of the housing of the process gas conduction space). In this case the surface is functionalized by alloying or on the surface of the gas conduction part that faces the interior of the process gas conduction space. In the case of MSCs, the gas conduction part is formed preferably by the edge region of the metallic support substrate which extends beyond the region of the electrochemical cell unit. The gas conduction part is therefore formed by the edge-side part of the metallic support substrate on which there are no electrochemically active layers. The gas conduction part in this case is produced in unison with the support substrate, preferably monolithically, i.e. from one piece. The functionalization here is accomplished preferably by means of an element or compound that is not yet included in the base material of the support substrate. Particularly in the case of a support substrate containing Fe and/or Cr, an additional element or an additional compound is provided as functionalization. So that the gas conduction part is able in this region to fulfil its function as a housing, the porous gas conduction part must of course be made gastight, something which may be achieved, for example, by pressing and/or local superficial melting on the side facing away from the process gas conduction space. In one preferred variant, the gas conduction part is implemented as an integral part of the support substrate, and the functionalization is accomplished not by alloying but instead by coating of the surface, in particular by means of vapour deposition methods, dip coating or methods for application of suspensions or pastes. The gain here is in flexibility, since the functionalization can be configured differently for different regions at comparatively favourable cost and can be optimized for the particular requirement. For example, the edge region of the support substrate via whose gas passage openings the process gas is supplied may be functionalized differently from the edge region of the support substrate via whose gas passage openings the process gas is removed.

In addition to the manipulation of the process gases and to mechanical functions (primarily in the case of a separately implemented gas conduction part), the gas conduction part has an important task in improving the gas flow within the process gas conduction space. In order to optimize the flow of gas, there may be gas guide structures formed on the gas conduction part, to convey the gas flowing in through the gas passage openings into the inner region of the process gas space, to the gas guide structures of the interconnector, and, respectively, to conduct outflowing gas from the inner region of the process gas space to the gas passage openings which lead out. The gas guide structures here may differ in design according to whether the gas conduction part is to fulfil a gas distributor function or a gas collector function. The functionalization of the gas conduction part may be coupled to the shape of the gas conduction structures; in other words, it can be deliberately made more intense in those surface regions which have more intense contact with the process gas.

The text below addresses possible forms of optimization of the gas guide structures, using the example of a separately implemented gas conduction part. Where appropriate, individual aspects may of course be transposed to gas conduction parts which are implemented as part of the housing, and for which the functionalized surface facing the process gas conduction space is provided with corresponding gas guide structures. Continuous gas passage openings may be integrated into the gas conduction part, and, in the arrangement in the electrochemical module, the gas passage openings of the gas conduction part may be aligned with the gas passage openings of the process gas conduction space (housing), thereby producing a vertically continuous gas channel within the stack. The gas conduction part is gas-permeable at least in one direction in the plane of principal extent from the gas passage opening up to a side edge facing the inner process gas space. For this purpose, the gas conduction part may have, generally or at least in this direction, an open, continuous porosity, and in this case in particular the inner surface past which the process gas flows is functionalized. In order to optimize the gas flow, the gas permeability (porosity) of the gas conduction part may vary spatially (for example through a gradation in the porosity or through locally different densification of the gas conduction part, in particular as a result of uneven pressing) and/or, for a higher gas throughput rate, the gas conduction part may alternatively or additionally have at least one channel or a plurality of channels along the plane of principal extent. The channel or channels whose surfaces advantageously are functionalized are preferably formed superficially and may be made in the surface of the gas conduction part (either gas conduction part implemented as housing part, or component implemented separately therefrom) by means, for example, of milling, pressing or rolling with corresponding structures. For the purposes of the present specification, a porous gas conduction part with a closed porosity and a superficial channel structure which runs from the gas passage opening up to a side edge is also considered to be gas-permeable from the gas passage opening up to the side edge. It is also conceivable for the channel or channels to extend at least sectionally over the entire thickness of the gas conduction part, and hence for the channels to be formed not just superficially. The advantage of this embodiment is a higher gas throughput rate, but it must be ensured that the component remains a single part and does not fall apart. In order to prevent this, the channels extending over the entire thickness may undergo transition, over their course, into superficial channel structures or porous structures. The number and shape of the channels is optimized for the flow properties and for the desired reactions.

The gas conduction part of the invention is produced by power metallurgy, with the material for functionalization being added to the starting powder during the production of the sintered component itself, and/or the surface of the component being covered at least sectionally with said material only after the sintering operation. Serving as starting material for the production of the gas conduction part is a preferably metal-containing powder, more preferably a powder of a corrosion-stable alloy such as, for example, a powder of a materials combination based on Cr (chromium) and/or Fe (iron), meaning that the Cr and Fe fraction is in total at least 50% by weight, preferably in total at least 80% by weight, more preferably at least 90% by weight. The gas conduction part in this case consists of a ferritic alloy. The gas conduction part is produced, preferably by powder metallurgy, in a known way by pressing of the starting powder (optionally with addition of the material for functionalization), optionally with addition of organic binders, and a subsequent sintering operation.

Where the gas conduction part is used as a separately formed component in an MSC, the gas conduction part consists preferably of the same material or a material largely the same (i.e. just with addition of the material for the functionalization) as the support substrate of the MSC. This is advantageous because in this case the thermal expansion is the same and there are no temperature-induced stresses.

As already mentioned, the gas conduction part of the invention finds use in an electrochemical module, in particular in an MSC. In one preferred embodiment, the electrochemical module has gas conduction parts each designed differently for the supplying and removal of the process gases. In this case, the gas conduction parts may differ in terms of the material used, their shape, porosity, the shape of the gas guide structures formed, such as the channel structures, etc. In particular, the functionalization may differ in the case of the gas conduction parts used for the supply and the removal of the process gases, and may be optimized for the various tasks. While the gas conduction part which is used in the supplying of process gases (reactant gases) is adapted for the treatment of the reactant gases, the gas conduction part which is used for the removal of process gases (product gases) is adapted for the post-treatment of the product gases.

Particularly in the case of use in an SOFC, the gas conduction part may be functionalized for the catalytic reforming of the reactant gas. For the catalytic reforming, the following materials are established (particularly when using a gas conduction part made from an alloy produced by powder metallurgy and based on iron and/or chromium): nickel (Ni), platinum (Pt), palladium (Pd) and/or oxides of these metals such as NiO, for example. In the case of homogeneous alloying, the fraction of these metals and/or metal oxides ought in total to be at least 1 wt %, preferably at least 2 wt %. As a result of this functionalization, additional hydrogen is generated for the electrochemical reaction, with no change in reactant gas flow rate. For the preferred effect, these materials can be alloyed into the base material and/or applied by coating methods to the surface which the process gas flows against and/or over (as for example applied by dip coating (suspension dipping) or various deposition techniques from the vapour phase), in which case alloying and vapour deposition methods are preferred over a dipping method owing to wetting effects which are deleterious to the porous structure.

The gas conduction part may further be functionalized for the purification of the reactant gas in respect of impurities such as, for example, of sulfur, chlorine, oxygen and/or carbon. The impurities react with the materials introduced, so reducing the risk of possible damage to the electrochemically active layers of the cell unit. Elements (getter atoms) used in purifying the reactant gas to remove sulfur and/or chlorine are as follows: Ni, cobalt (Co), chromium (Cr), scandium (Sc) and/or cerium (Ce), with Ni being preferred on account of its properties as noted above in relation to catalytic reforming, and Ce being preferred as well. Preferred elements for purifying the product gas with respect to oxygen are Cr, copper (Cu) and/or titanium (Ti), with Ti being particularly advantageous on account of its retentive effect for carbon and hence for its simultaneous effect in preventing formation of soot. Although these getter atoms may generally retain only residual quantities in the ppm range, they have a measurably positive influence on the performance and lifetime of the electrochemical module. Here as well, the materials are introduced by alloying into the base material, dip coating with suspensions or deposition methods from the vapour phase, with vapour deposition methods being preferred on account of flexibility.

Functional centres for post-treatment of the product gas may be introduced analogously. The product gas (outgoing gas) may be purified by a correspondingly functionalized gas conduction part, especially in respect of impurities comprising volatile Cr ions. A corresponding functionalization relative to Cr impurities may be accomplished by oxidic ceramics such as, for example, Cu—Ni—Mn spinels of the structure AB₂O₄ (where A is an element from the group of Cu or Ni and B is the element manganese (Mn)), and may take place by vapour deposition methods, dipping methods or application methods for suspensions and/or pastes, or by conversion from the metallic elements.

In order to prevent backwards diffusion of oxygen from the outgoing-gas lines, the gas conduction part may be functionalized with oxygen getters. These getters are intended to prevent oxidation of the anode. Suitable oxygen getters are as follows: Ti, Cu or sub-stoichiometric spinel compounds, with preference being given to using Ti and/or Cu. These two metals are applied to the porous surface of the gas conduction part preferably by a vapour deposition method. The suppression of backwards diffusion may optionally be supported additionally by means of suitable gas conduction structures.

In summary, particularly for use in an SOFC, the gas conduction part may be functionalized on the reactant-gas side with Ni, Pt, Pd (and/or oxides of these metals), Co, Cr, Sc, cerium, Cu and/or Ti. Possible functionalizations of the gas conduction part on the product side include Ti, Cu and/or oxidic ceramics, especially Cu—Ni—Mn spinels. Preferred combinations for the functionalization of the gas conduction parts on reactant-gas side and product-gas side comprise Ni or NiO on the reactant-gas side and Ti on the product-gas side, and also Ni or NiO on the reactant-gas side and Cu on the product-gas side, etc.

Further advantages of the invention will become apparent from the description hereinafter of exemplary embodiments with reference to the appended figures, in which, for purposes of illustration of the present invention, the size proportions are not always given accurately to scale. In the various figures, the same reference symbols are used for matching components.

Of the figures:

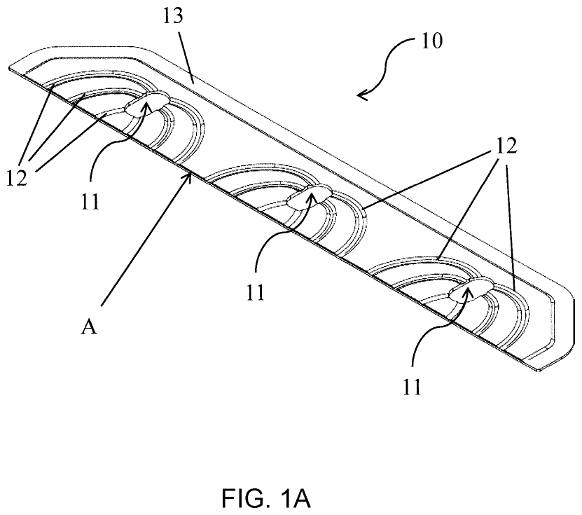

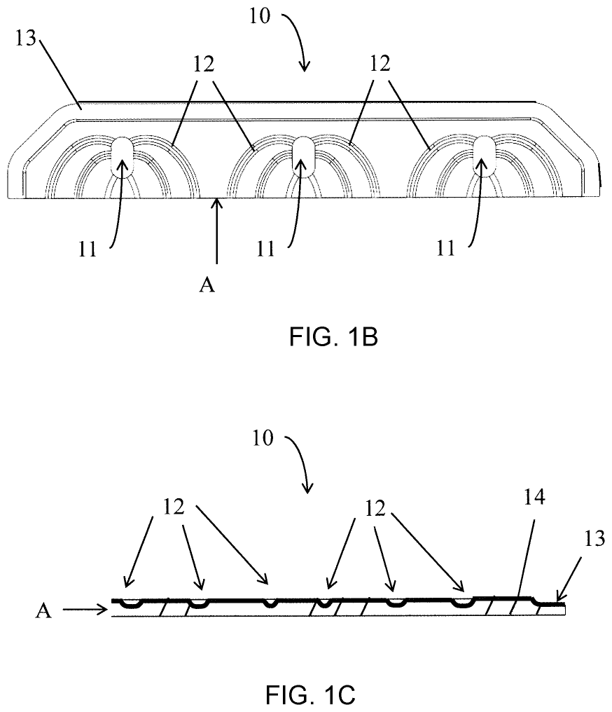

FIG. 1a: shows a first embodiment of a functionalized gas conduction part for use in an electrochemical module, in perspective view;

FIG. 1b: shows the gas conduction part of FIG. 1a in plan view; and

FIG. 1c: shows the gas conduction part of FIG. 1 a in a side view;

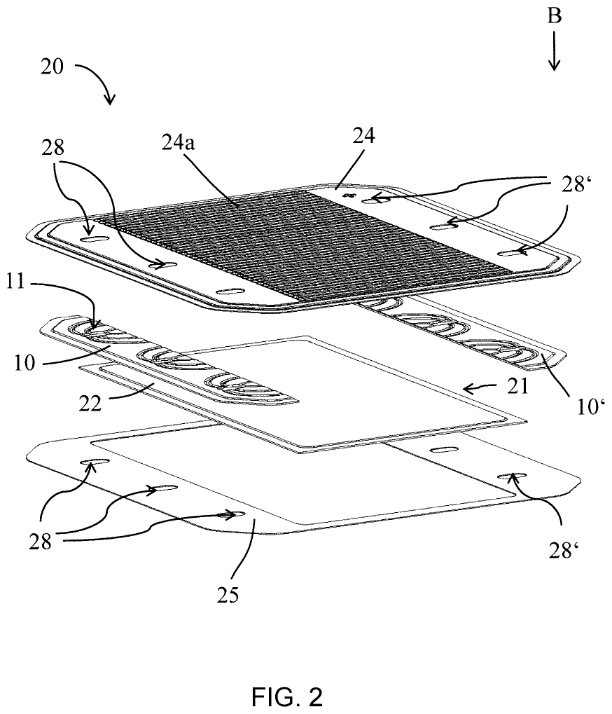

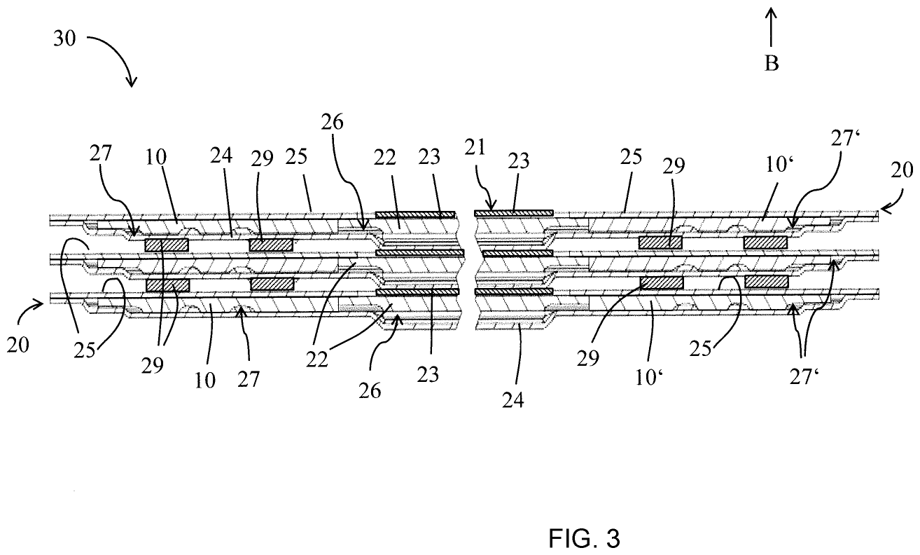

FIG. 2: shows a first embodiment of the electrochemical module with a gas conduction part according, respectively, to FIG. 1a-c for the process gas conduction space, for the supply or removal of the process gases, respectively, in an exploded view (here it must be borne in mind that, in comparison to the modules in FIG. 3, the electrochemical module in FIG. 2 is shown turned on its head for improved visibility of the channels);

FIG. 3: shows a stack with three electrochemical modules as per FIG. 2, in cross section;

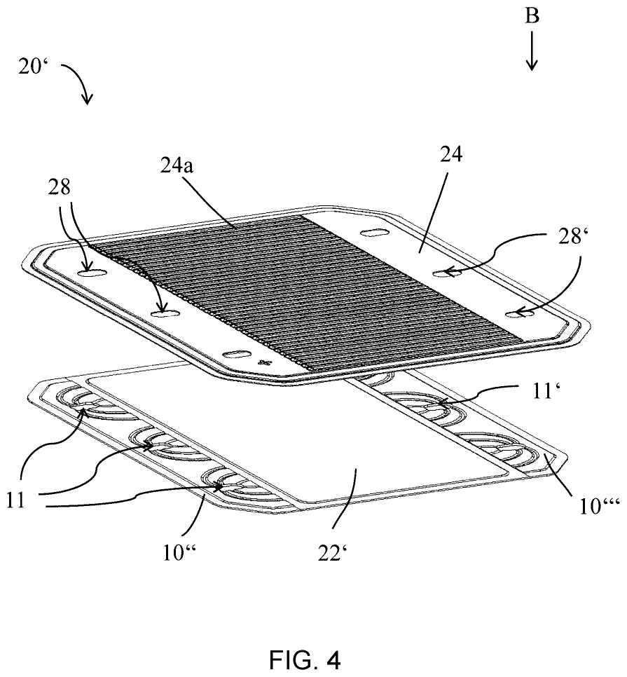

FIG. 4: shows a second embodiment of the electrochemical module, in an exploded view, and

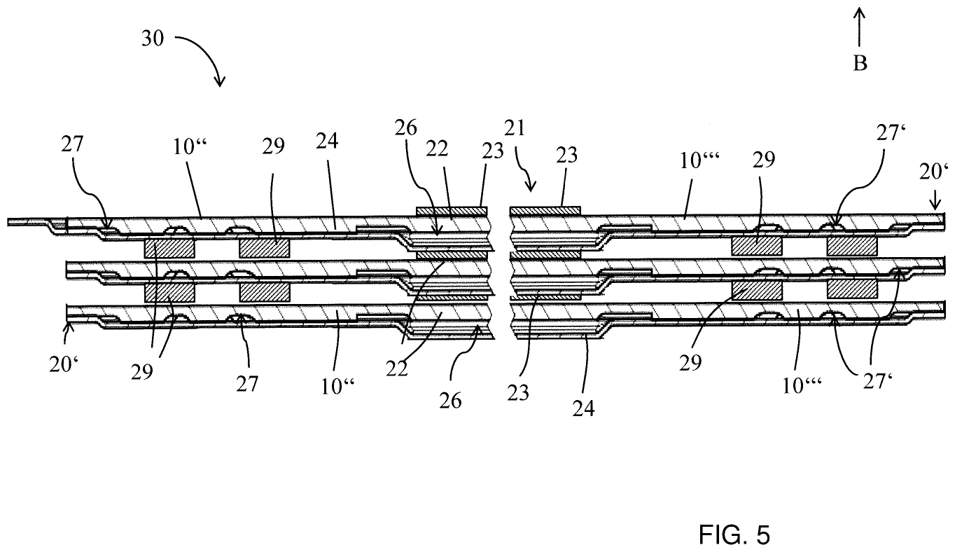

FIG. 5: shows a stack with three electrochemical modules as per FIG. 4, in cross section.

FIG. 1a shows, in a perspective view, a first embodiment of the functionalized gas conduction part (10), which is configured as a separate component and is arranged in the electrochemical module, in particular in an SOFC, within the process gas conduction space. One possible arrangement in the process gas conduction space is apparent from the following FIG. 2 and FIG. 3. FIG. 1b shows the gas conduction part (10) in plan view, and it is shown in FIG. 1c in a side view from the side (A), which in the arrangement in the electrochemical module (20) is facing the interior of the process gas space. The gas conduction part (10) is produced by powder metallurgy from an Fe-based alloy with >50 wt % Fe and 15 to 35 wt % Cr. A powder having a particle size <150 μm, more particularly <100 μm, was selected, so that after the sintering operation the porous gas conduction part has a porosity of preferably 20 to 60%, more particularly 40 to 50%. The thinner the gas conduction part to be formed, the smaller the selected particle size. With preference an open porosity is established (i.e., with the possibility of gas exchange between individual adjacent pores). The thickness of the part is preferably in the range from 170 μm to 1.5 mm, more particularly in the range from 250 μm to 800 μm. The flat gas conduction part has a plurality of gas passage openings (11)—in the variant depicted, three central gas passage openings (11)—through which the process gas is supplied and, respectively, removed in the operation of the electrochemical module. The process gas flow is additionally steered by gas guide structures—in the present exemplary embodiment, by star-shaped channels (12) which are formed superficially and extend from the gas passage openings up to the side edge (A). Channels which branch off from the gas passage opening (11) originally in a direction remote from the inner process gas space are redirected here in an arc shape to the side edge (A) in the direction of inner process gas space. At the remaining side edges (13) (apart from side edge (A)), the gas conduction part has been pressed in a gastight manner. In the operation of the electrochemical module, the process gas flows from the gas passage openings (11) through the channels (12) and through the pores to the side edge (A) of the gas conduction part, from which it flows on into the interior process gas space, which is supplied extremely uniformly by the numerous channels. When the gas conduction part is used for removing the process gases, the gas flows in the opposite direction.

For the functionalization, the surface of the gas conduction part on the side with the channels was coated in a PVD unit with a functional layer (14) <1 μm in thickness. In this operation, care was taken to ensure that the porous surface structure of the gas conduction part is retained in the course of coating, i.e., the openly porous surface is not overlayered by a top coat, so that there continues to be a functionalized surface area which is large in comparison to a smooth surface. Care was also taken to ensure that, in particular, the surface of the channels over which the process gas flow passes, and which is therefore in comparatively intensive contact with the process gas, was sufficiently coated.

A plurality of gas conduction parts with different functionalization for the treatment or post-treatment of the process gases, respectively, were produced, these gas conduction parts being intended for use in an SOFC. A first exemplary embodiment of the gas conduction part was coated with Ni, and a second one with NiO. Both gas conduction parts find application in the treatment of combustion gases; the functionalized surface of both exemplary embodiments serves as a catalyst for the reforming of the combustion gas and also has a getter effect in relation to chlorine and sulfur. For the gas conduction part for the post-treatment of outgoing gas, a Ti coating was selected which filters Cr ions from the flow of outgoing gas.

FIG. 2 and FIG. 3 illustrate the arrangement of the gas conduction parts (10,10′) in the electrochemical module. FIG. 2 shows, in an exploded view, an electrochemical module (20) having correspondingly functionalized gas conduction parts (10, 10′); FIG. 3, in a cross-sectional view, represents a stack (30) having three electrochemical modules (20) stacked on top of one another. It should be borne in mind that in FIG. 2, in comparison to the modules in FIG. 3, the electrochemical module is shown turned on its head for better visibility of the channels (12). The electrochemical modules (20) each have an electrochemical cell unit (21) which consists of a porous, metallic support substrate (22) which has been produced by powder metallurgy, with a layer construction (23) with at least one electrochemically active layer applied on this substrate (22) in a gas-permeable region. The support substrate (22) with the layer construction (23) is pressed together in a gastight manner at the edge and has a plate-shaped base structure which in variant embodiments, for enlargement of surface area, may also have local curvature—for example, a wave-shaped design—over a smaller length scale. Located on the side of the support substrate (22) that is opposite the layer construction there is in each case an interconnector (24), which in the region where it bears against the support substrate (22) has a rib structure (24a). The longitudinal direction of the rib structure runs here in the cross-sectional plane in FIG. 3. The interconnector (24) extends at two opposite sides beyond the region of the electrochemical cell unit (21) and bears at its outer edge against a frame panel (25) circumscribing the electrochemical cell unit. The circumscriptive frame panel (25) is joined in gastight fashion to the electrochemical cell unit (21) at the inner edge, and is joined in gastight fashion to the interconnector (24) at the outer edge, via a circumscriptive welded connection. The frame panel (25) and the interconnector (24) thus form a constituent of a metallic, gastight housing which, with the electrochemical cell unit (21), delimits a gastight process gas space (26). The process gas space (26) is subdivided (conceptually) into two opposite sub-spaces—the two process gas conduction spaces (27, 27′)—with the sub-spaces each extending over a region outside the region of the electrochemical cell unit (21) and being open in the direction of electrochemical cell unit (21). In this arrangement, a first process gas conduction space (27) serves, via corresponding gas entry openings (28) in the housing (frame panel and interconnector), for the supply of the process gases, whereas the opposite process gas conduction space (27′) serves, via corresponding gas exit openings (28′), for removal of the process gases (the gas passage openings are not shown in FIG. 3, since the section is located to the side of the gas passage openings). The conducting of gas within the stack takes place in a vertical direction (stack direction of the stack (B)) by means of corresponding channel structures, which are formed in the region of the gas passage openings customarily by means of separate inlays (29), seals, and also by controlled application of sealant (e.g. glass solder).

Arranged within the process gas conduction space (27) for supply is a gas conduction part (10) whose surface is functionalized for the treatment of the reactant gas (reforming, purification). The gas conduction part (10′) functionalized for the post-treatment of the product gases is arranged within the opposite process gas conduction space (27′) for the removal of the product gases. The gas conduction parts (10, 10′) used for supply and removal therefore preferably have different functionalization. The gas conduction parts may of course also differ in other properties (base material, shape, porosity, geometry of channels, etc) and may be optimized independently of one another for their intended use.

The gas conduction parts (10,10′) are preferably configured as a support element in the stack direction (B) of the electrochemical modules. For this purpose, the shape of the gas conduction part is adapted in each case to the interior of the respective process gas conduction space. Each of the gas conduction parts (10, 10′) bears by its top side against the frame panel (25), the upper boundary of the respective process gas conduction space (27, 27′), and by its bottom side against the interconnector (24), the lower boundary of the respective process gas conduction space. A flat contact is advantageous in particular, at the top side and/or at the bottom side of the respective gas conduction part. The thickness of the gas conduction part therefore corresponds to the space internal height of the respective process gas conduction space (27,27′). The channels (12) formed superficially are located on the underside of the gas conduction parts (10,10′). Because of the flat architecture of the gas conduction parts, the flexural and torsional stiffness of the housing edge region, which consists of a thin frame panel (25) and a thin interconnector (24), is decisively increased and hence the risk of cracking in the weld seams under mechanical loading is reduced. In one advantageous variant embodiment, the functionalized gas conduction parts are spot-welded on the housing and fixed accordingly.

FIG. 4 and FIG. 5 show a second exemplary embodiment of the electrochemical module (20′), in which the gas conduction parts (10″,10′″) form part of the housing and are implemented integrally with the support substrate (22′). The porous support substrate (22′) is pressed in gastight manner on two opposite sides, in each case at the edge region, in each of which sides there are gas passage openings (11,11′) integrated. The edge region may also be made gastight on the side facing the layer construction (23) by means of a melting operation effected, for example, by laser beam melting. These opposite edge regions of the support substrate are outside the gas-permeable region with the layer construction (23). They each represent a gas conduction part (10″,10′″) and delimit the two process gas conduction spaces (27,27′) towards the top. In the pressing procedure, optionally, gas guide structures (12) may be integrated on the underside (side facing the interior of the process gas conduction space) of the edge region of the support substrate. In the variant realized, the edge region (10″) of the support substrate that is assigned to the supply of the combustion gas is coated on its underside with Ni; the edge region (10′″) assigned to the removal of the outgoing gas is coated on its underside with Ti. Treatment of the combustion gases and purification of the outgoing gases are achieved in a manner analogous to the exemplary embodiment from FIG. 1 to FIG. 3.

Not only for the exemplary embodiment shown in FIG. 1 to FIG. 3, with a separate gas conduction part, but also for the exemplary embodiment shown in FIG. 4 and FIG. 5, with the integrated gas conduction part, there are of course functionalizations conceivable that are other than the Ni and/or NiO and the Ti coating. For use in an SOFC, the gas conduction part may be functionalized on the reactant-gas side not only with Ni or NiO but also with Pt, Pd (and/or oxides of these two metals), Co, Cr, Sc, cerium, Cu and/or Ti. Possible functionalizations of the gas conduction part on the product side include Ti, Cu and/or oxidic ceramics, more particularly Cu—Ni—Mn spinels.

1-20. (canceled)

21. A porous or at least sectionally porous gas conduction part for an electrochemical module, the electrochemical module containing at least one electrochemical cell unit having a layer construction with at least one electrochemically active layer, and a metallic, gastight housing forming a gastight process gas space with the electrochemical cell unit, wherein on at least one side the metallic, gastight housing extending beyond a region of the electrochemical cell unit, and forms a process gas conduction space open to the electrochemical cell unit, and in a region of the process gas conduction space having at least one gas passage opening for a supply and/or removal of process gases, the gas conduction part comprising:
a gas conduction part body being adapted for arrangement within the process gas conduction space and a surface of the gas conduction part body being functionalized for interaction with a process gas.

22. The gas conduction part according to claim 21, wherein said gas conduction part body is configured as a separate component from the electrochemical cell unit.

23. The gas conduction part according to claim 21, wherein said gas conduction part body is adapted for supporting the metallic, gastight housing on both sides along a stack direction of the electrochemical module.

24. A porous or at least sectionally porous gas conduction part for an electrochemical module, the electrochemical module containing at least one electrochemical cell unit having a layer construction with at least one electrochemically active layer, and a metallic, gastight housing forming a gastight process gas space with the electrochemical cell unit, wherein on at least one side the metallic, gastight housing extending beyond a region of the electrochemical cell unit and forming a process gas conduction space open to the electrochemical cell unit, and in a region of the process gas conduction space having at least one gas passage opening formed therein for a supply and/or removal of process gases, the gas conduction part comprising:
a gas conduction part body configured as a housing part of the process gas conduction space and a surface of said gas conduction part body that faces a process gas conduction interior is functionalized for interaction with a process gas.

25. The gas conduction part according to claim 24, wherein said gas conduction part body is formed integrally with a metallic support substrate of the electrochemical cell unit.

26. The gas conduction part according to claim 24, wherein said gas conduction part body is functionalized for catalytic reforming a reactant gas.

27. The gas conduction part according to claim 26, wherein a functionalization for the catalytic reforming is accomplished by introduction of nickel, platinum and/or palladium and/or oxides of these metals.

28. The gas conduction part according to claim 24, wherein said gas conduction part body is functionalized for purifying a reactant gas.

29. The gas conduction part according to claim 28, wherein a functionalization for purifying the reactant gas with respect to sulfur and/or chlorine is accomplished by introduction of nickel, cobalt, chromium and/or cerium.

30. The gas conduction part according to claim 28, wherein a functionalization for purifying the reactant gas with respect to oxygen is accomplished by introduction of chromium, copper and/or titanium.

31. The gas conduction part according to claim 28, wherein a functionalization for purifying the reactant gas with respect to carbon is accomplished by introduction of titanium.

32. The gas conduction part according to claim 24, wherein said gas conduction part body is functionalized for purifying a product gas.

33. The gas conduction part according to claim 32, wherein a functionalization for purifying the product gas with respect to chromium is accomplished by introduction of oxidic ceramics.

34. The gas conduction part according to claim 32, wherein a functionalization for purification with respect to oxygen is accomplished by introduction of Ti and/or Cu or sub-stoichiometric spinel compounds.

35. The gas conduction part according to claim 27, wherein the introduction is accomplished by alloying or by a coating procedure.

36. The gas conduction part according to claim 24, wherein said gas conduction part body has a base material being a ferritic alloy produced by powder metallurgy and based on iron and/or chromium.

37. The gas conduction part according to claim 24, wherein said gas conduction part body has at least one gas guide structure.

38. An electrochemical module, comprising:
a substantially plate-shaped electrochemical cell unit having a layer construction with at least one electrochemically active layer;
a metallic, gastight housing forming a gastight process gas space with said electrochemical cell unit, wherein on at least one side said metallic, gastight housing extending beyond a region of said electrochemical cell unit, and said metallic, gastight housing forming a process gas conduction space open to said electrochemical cell unit, said metallic, gastight housing having gas passage openings formed therein in a region of said process gas conduction space for a supply and/or removal of process gases;
at least one of:
at least one gas conduction part disposed within said process gas conduction space in a region of said gas passage openings, said at least one gas conduction part having a surface functionalized for interaction with a process gas, said at least one gas conduction part disposed and serving to support said metallic, gastight housing along a stack direction of the electrochemical module; or
said metallic, gastight housing having said process gas conduction space is formed at least sectionally by at least one gas conduction part, said at least one gas conduction part having at least a surface facing a process gas conduction interior and being functionalized for interaction with a process gas.

39. The electrochemical module according to claim 38, wherein said metallic, gastight housing containing at least two sides that extend beyond a region of said electrochemical cell unit, and forming a first process gas conduction space having at least one gas entry opening for a reactant gas, to which at least one first said gas conduction part is assigned, and a second process gas conduction space having at least one gas exit opening for a product gas, to which at least one second said gas conduction part is assigned, where a functionalization of said first gas conduction part assigned to said first process gas conduction space differs from a functionalization of said second gas conduction part assigned to said second process gas conduction space.

40. The electrochemical module according to claim 39, wherein said first gas conduction part is functionalized for treatment of a reactant gas and/or said second gas conduction part is functionalized for post-treatment of the product gas.
